(19) United States
(12) Patent Application Publication
(10) Pub. No.: US 2026/0097981 A1
(43) Pub. Date: Apr. 9, 2026

(54) METHOD FOR THE TREATMENT OF COMPLEX WASTE

(71) Applicant: SUEZ INTERNATIONAL, Puteaux (FR)

(72) Inventors: Pierre-Emmanuel PARDO, Paris La Défense Cedex (FR); Safwan AL AYOUBI, Paris La Défense Cedex (FR)

(73) Assignee: SUEZ INTERNATIONAL, Puteaux (FR)

(21) Appl. No.: 19/112,313

(22) PCT Filed: Sep. 28, 2023
(86) PCT No.: PCT/EP2023/076991

§ 371 Date: Mar. 17, 2025

(30) Foreign Application Priority Data
Sep. 29, 2022 (FR) FR2209944

(51) Int. Cl. C02F 9/00; C02F 11/04; C02F 11/18

(52) U.S. Cl. CPC C02F 9/00; C02F 11/04; C02F 11/18; C02F 2303/10

(57) ABSTRACT

A method for treating a mixture M1 comprising at least organic matter. The method involves hydrolyzing mixture M1 to obtain a hydrolyzed mixture M1h. The mixture M1h is pressurized to obtain a stream M1p. M1p is heated to obtain a mixture M2. At least a fraction of M2 is solubilized, optionally heated, and separated to obtain a stream M4 enriched with soluble materials and a stream M3 depleted of soluble materials. At least one fraction of the stream M4 enriched with soluble materials is cooled and expanded to obtain a stream M5. Finally, at least one fraction of the stream M5 is digested.

### TECHNICAL FIELD OF THE INVENTION

The invention relates to the field of treatment of complex waste, comprising organic and inorganic matter, such as aqueous waste, sludge, and sewage.

### STATE OF THE ART

Sludge digestion, carried out in a digester, is a partial biological degradation of organic matter, resulting from a succession of reactions, leading to the formation of a gaseous mixture known as biogas. This biogas is a source of energy, whether recovered in the form of electricity or heat, or used as a fuel, notably as motor fuel or injected as town gas.

The digestion process involves micro-organisms, mainly bacteria, which break down or convert the raw materials to produce biogas and effluent. The process involves a series of reactions involving bacteria, mainly hydrolysis, acidogenesis, acetogenesis and methanogenesis.

Hereinafter, the term “biogas” will be used to describe the gas resulting from the digestion process. This biogas comprises a mixture substantially consisting of methane, carbon dioxide and water. The biogas may optionally comprise other gases, such as hydrogen, oxygen, nitrogen, hydrogen sulfide but they collectively represent less than 10% of the biogas. Biogas can be burned directly with oxygen and be used as a fuel. The methane contained in biogas (known as biomethane) can also be concentrated to replace natural gas.

Prior art processes are typically not sufficiently selective. The yields are insufficient for a large proportion of organic matter since they are often limited to 30-35% yield on organic matter.

The concept of thermal hydrolysis has been implemented and allows digestion yields to be increased by 5 to 15%. These batch or continuous concepts are based on a temperature of 140-170° C. and a residence time of 30 minutes. These yields are certainly interesting but a large part of the increase in yield goes to heating this equipment since heat recovery always involves heating the initial product to around 100° C.

Furthermore, these treatments focus on the organic part of the material and neglect any interest in recovering the mineral fraction which is rich in phosphorus for example.

There is therefore a need to propose a treatment method with a high yield, good thermal management and improved quality of the treated material for the recovery of waste containing organic matter and inorganic matter.

### SUMMARY OF THE INVENTION

The invention relates to a method for treating a mixture M1 comprising at least organic matter, said method comprising:
a) a step of hydrolyzing mixture M1 at a temperature ranging from 70 to 165° C. and at a pressure ranging from 1 to 8 bar making it possible to obtain a hydrolyzed mixture M1h, the ratio between the viscosity of mixture M1 and the viscosity of mixture M1h being at least 2,
b) pressurizing mixture M1h at a pressure of 20 to 350 bar, in order to obtain a stream M1p,
c) a step of heating mixture M1p resulting from step b) at a temperature ranging from 250° C. to 450° C., in order to obtain a mixture M2,
d) a solubilization step carried out on at least one fraction of mixture M2 resulting from step c), optionally a heating step at a temperature ranging from 250 to 450° C., and a separation step in order to obtain a stream M4 enriched with soluble materials and a stream M3 depleted of soluble materials,
said step d) being implemented in one or more reactors with an overall hydraulic residence time of less than or equal to 20 minutes,
e) a step of cooling and expanding at least one fraction of the stream M4 enriched with soluble materials resulting from step d), in order to obtain a stream M5,
f) a digestion step implemented on at least one fraction of the stream M5 resulting from step e).

According to one embodiment, the method of the invention further comprises an additional separation step e′) implemented on at least one fraction of stream M5 resulting from step e) making it possible to obtain a gaseous fraction FG and a liquid stream M5′, the digestion step f) then being carried out in a digester on at least one fraction, preferably all, of the liquid stream M5′, said gaseous fraction FG preferably also being introduced into the digester during said digestion step f).

Preferably, the separation step comprises an extraction of stream M4 enriched with soluble materials and an extraction of stream M3 depleted of soluble materials, preferably via two separately controlled outlets.

According to one embodiment, heating step c) comprises at least two sub-steps, at least one of said sub-steps allowing mixture M1p to be heated at a rate greater than or equal to 100° C./minute, preferably greater than or equal to 200°C/minute, even more preferably greater than or equal to 400° C./minute.

Preferably, the heat present in stream M4 enriched with soluble materials resulting from step d) is recovered. Preferably, the heat is recovered by heat exchange between stream M4 enriched with soluble materials resulting from step d) and mixture M1p, preferably said heat exchange allows mixture M1p to be at least partially heated during heating step c).

According to one embodiment, in step e), stream M4 enriched with soluble materials is cooled to a temperature of less than or equal to 60° C., preferably less than or equal to 40° C.

According to one embodiment, said cooling step comprises at least two sub-steps, preferably said first sub-step is implemented by heat exchange between the heat of stream M4 and mixture M1p and makes it possible to obtain a cooled stream M4′ and said second sub-step is a step of expanding the cooled stream M4′ at a pressure ranging from 2 to 10 bar making it possible to produce expansion steam, said expansion steam can optionally be injected into mixture M1 upstream of step a) or during step a).

According to one embodiment, mixture M1 comprises from 5 to 50% by weight of solids, preferably from 15 to 25% by weight of solids, with respect to the total weight of mixture M1.

According to one embodiment, at least one additive is added to at least one stream selected from:
The stream of mixture M1 upstream of step a),
Mixture M1 during step a),
the stream of mixture M1h upstream of step b),
the stream of mixture M1p upstream of step c),
mixture M1p during step c),
the stream of mixture during step d),
stream M3 depleted of soluble materials resulting from step d).

According to one embodiment, the method of the invention further comprises at least one step of recovering at least one fraction of stream M3, said at least one recovery step being preferably selected from a hydrothermal gasification step, a wet oxidation step.

The invention also relates to an installation for implementing a treatment method according to the invention, said installation comprising:
At least one hydrolysis reactor 1 optionally comprising a stirring device, supplied at the inlet by a feed line for mixture M1 to be treated and comprising an outlet line for the hydrolyzed mixture, said at least one hydrolysis reactor being optionally preceded by a grinding device or provided with a recirculation loop equipped with a grinding device or followed by a grinding device, upstream of the pump 3,
a pressurization pump 3 supplied at the inlet by the hydrolyzed mixture, which is optionally ground, and comprising an outlet line for mixture M1p,
a heating device 4 comprising an inlet for introducing at least one fraction of mixture M1p downstream of the pump 3, and comprising at least one outlet for mixture M2,
a reactor 5 comprising an inlet for introducing at least some of mixture M2 resulting from the heating device 4 and comprising at least two outlets, one outlet for stream M3 and one outlet for stream M4,
said reactor 5 optionally comprising heating means, and
said reactor 5 comprising separation means for extracting a stream M3 depleted of soluble materials and a stream M4 enriched with soluble materials,
optionally a heat exchanger 9 for recovering the heat present in stream M4 enriched with soluble materials at the outlet of the reactor 5,
an expansion device 10 supplied with at least one fraction of stream M4 enriched with pre-cooled soluble materials, and comprising an outlet for stream M5
optionally a separation device 12 supplied by at least one fraction of stream M5 and comprising an outlet for a gaseous fraction and an outlet for liquid stream M5′,
a digestion device 11 supplied with at least one fraction of stream M5 or where applicable with at least one fraction of liquid stream M5′ and at least part of the gaseous fraction.

According to one embodiment, the reactor 5 comprises:
a solubilization reactor 52 comprising an inlet for introducing at least part of mixture M2 resulting from the heating device 4 and comprising an outlet line for a mixture M6,
optionally a heating device 53 comprising an inlet for introducing at least part of mixture M6 resulting from the solubilization reactor 52 and comprising an outlet line for a mixture M6′,
a separation device 51 supplied with at least one fraction of mixture M6 or with at least one fraction of mixture M6′ when a heating device 53 is present, and comprising at least two outlets, one outlet for stream M3 and one outlet for stream M4.

According to one embodiment, the heating device 4 comprises a heat exchanger for exchanging heat between stream M4 enriched with soluble materials resulting from the reactor 5 and stream M1p downstream of the pressurization pump 3, a cooled stream M4′ thus being obtained.

According to one embodiment, the installation further comprises a heat exchanger 9 downstream of the heating device 4 for recovering the heat present in stream M4′ and transferring it to mixture M1 for thermal hydrolysis, preferably via steam generation.

The invention improves the treatment of an organic matter in a complex matrix. Improved treatment allows better recovery on the one hand of inorganic matter, such as salts, and on the other hand of organic matter.

The treatment method according to the invention is energy-efficient, without compromising the quality of the recovery.

The inventors have observed that increasing temperatures beyond hydrolysis temperatures can lead to the production of compounds that are potentially resistant to digestion, in particular due to long residence times which lead to molecular reorganization of the short chains produced by hydrolysis or by radical destruction at these high temperatures. Thus, the invention makes it possible to control the residence times at these high temperatures and in particular the rate of temperature rise in order to improve digestibility.

The invention also features a solubilization step allowing water to act as a catalyst for chemical reactions, resulting in a more homogeneous mixture where all the material is in close contact with water. This solubilization step, carried out under controlled temperature and residence time conditions, improves the quality of the treated material for better digestion of said treated material.

### BRIEF DESCRIPTION OF THE FIGURES

FIG. 1 is a schematic depiction of a treatment method according to the invention.

FIG. 2 is a schematic depiction of a treatment method according to the invention.

FIG. 3 is a schematic depiction of a treatment method according to the invention.

### DETAILED DESCRIPTION OF THE INVENTION

The invention relates to a method for treating a mixture M1 comprising at least organic matter, said method comprising:
a. a step of hydrolyzing mixture M1 at a temperature ranging from 70 to 165° C. and at a pressure ranging from 1 to 8 bar making it possible to obtain a hydrolyzed mixture M1h, the ratio between the viscosity of mixture M1 and the viscosity of the M1h being at least 2, preferably at least 4, still preferably at least 10,
b. a step of pressurizing mixture M1h at a pressure ranging from 20 to 350 bar, preferably 170 to 210 bar, in order to obtain a stream M1p,
c. a step of heating mixture M1p resulting from step b) to a temperature ranging from 250° C. to 450° C., preferably 250 to 400° C., still preferably 250 to 350° C., in order to obtain a stream of mixture M2,
d. a solubilization step carried out on at least one fraction—preferably all—of mixture M2 resulting from step c), optionally a heating step at a temperature ranging from 250 to 450° C., preferably 250 to 400° C., still preferably 300 to 350° C., and a separation step in order to obtain a stream M4 enriched with soluble materials and a stream M3 depleted of soluble materials, said step d) being carried out in one or more reactors with an overall hydraulic residence time of less than or equal to 20 minutes, preferably less than or equal to 10 minutes, still preferably less than or equal to 5 minutes,
e. a step of cooling and expanding at least one fraction, preferably all, of stream M4 enriched with soluble materials resulting from step d), in order to obtain a stream of mixture M5,

e′. optionally a separation step carried out on at least one fraction—preferably all—of stream M5 resulting from step e) to obtain a gaseous fraction FG and a liquid stream M5′,
f. a digestion step carried out on at least one fraction, preferably all, of the stream of mixture M5 resulting from step e) or where applicable (i.e. when step e′) is present) on at least one fraction, preferably all, of the liquid stream M5′ and preferably on at least part of the gaseous fraction FG.

For the purposes of the present invention, the expression “at least one fraction of a mixture or stream” has the same meaning as the expression “all or part of said mixture or stream”. In the case of a part of said mixture or of said stream, this expression refers to a certain proportion of said mixture or said stream. For example, for the purposes of this expression, “each fraction of the mixture”or “each fraction of the stream”will have the same composition.

Thus, for the purposes of the present invention, the expression “step X carried out on all of stream M resulting from step Y” means that steps X and Y are successive and that there is no intermediate step or separation between steps X and Y.

For the purposes of the present invention, the expression “where applicable of step X” introduces a feature that is present when step X is present.

For the purposes of the present invention, the expression “where applicable of stream X” introduces a feature that is present when stream X is present.

### Mixture M1 Comprising at Least Organic Matter

Mixture M1 comprises at least organic matter. Typically, mixture M1 further comprises inorganic matter. Inorganic matter includes salts comprising anions such as phosphates, sulfates, chlorides, carbonates and hydrocarbonates with counterions such as sodium, magnesium, calcium, ammonium and metals.

Mixture M1 may for example be selected from primary, mixed or biological sludge from municipal and industrial wastewater treatment plants.

According to one embodiment, mixture M1 comprises from 5 to 50% by weight of solids, preferably from 15 to 25% by weight of solids, with respect to the total weight of mixture M1.

### Hydrolysis Step a)

The method according to the invention comprises a hydrolysis step of mixture M1.

The hydrolysis step is carried out at a temperature ranging from 70 to 165° C. and at a pressure ranging from 1 to 8 bar. These conditions prevent the medium from vaporizing.

According to one embodiment, the temperature during hydrolysis step a) ranges from 100 to 165° C., or even 140 to 165° C.

The hydrolysis step reduces the viscosity of the mixture. Thus, step a) allows a hydrolyzed mixture M1h also known as hydrolysate to be obtained.

The hydrolysis step allows the organic matter to be broken down, in particular by breaking the chemical bonds and depolymerizing the organic matter through the effect of water.

Mixture M1h will typically have a viscosity at least 2 times lower, preferably at least 4 times lower, even more preferably at least 10 times lower than the viscosity of mixture M1.

Thus, the ratio between the viscosity of mixture M1 and the viscosity of mixture M1h is at least 2, preferably at least 4, even more preferably at least 10.

The viscosity defined in the context of the present invention is a kinematic viscosity measured at the same temperature (e.g. 20° C.) using rheometers adapted to the viscosity to be measured (cylinder-cylinder, plane-plane) and by measuring the two viscosities at the same shear rate (in s⁻¹), typically taking care to eliminate turbulence problems and to comply with rheological rules (e.g. spacing between cylinders depending on particle size).

The hydrolysis step of mixture M1 can be carried out in one or more hydrolysis reactors in parallel or in series.

Said hydrolysis step allows mixture M1 to be hydrolyzed notably by maintaining an average hydraulic residence time at the desired temperatures and pressures (preferably temperatures ranging from 70 to 165° C. and pressures ranging from 1 to 8 bar), it being understood that if the hydrolysis step is carried out in several hydrolysis reactors, the temperature may be identical or different in the different reactors, and similarly, the pressure may be identical or different in the different reactors.

Advantageously, the hydrolysis step will carry out an internal energy recovery step, thus minimizing the heat consumption of hydrolysis. For example, there could be an energy recirculation loop from the hot hydrolysate to the cold product to be hydrolyzed, for example, by production of steam for expansion of the hot hydrolysate and injection into the cold product to be hydrolyzed or heat exchange.

At the end of the hydrolysis step, a hydrolysate M1h is obtained, which is not necessarily at the desired temperatures and pressures for hydrolysis. Indeed, before the end of the hydrolysis step, the hydrolysate may optionally undergo a cooling and/or expansion step.

In particular, for example if hydrolysis is carried out at a high temperature, for example ranging from 100 to 165° C., then it may be desirable to cool the hydrolysate to a temperature below 90° C. for example, so that stream M1h has a lower temperature for pressurization in step b) of the method of the invention

Extraction of the hydrolysate M1h can be controlled by measuring viscosity.

Within the context of the treatment method of the invention, the hydrolysis step achieves a dual objective:
On the one hand, by reducing viscosity, hydrolysis will allow better heat exchange and therefore a faster increase in temperature of mixture M1p. In addition, the lower viscosity will ensure uniformity of the temperature of mixture M1p becoming M2 during the heating step and will reduce or even prevent harmful carbonization reactions.
On the other hand, hydrolysis will bring a greater proportion of the solid matter in mixture M1 into contact with water, allowing the M1h material to be of better quality (more uniform) to prepare a stream of soluble materials via more homogeneous solubilization reactions (by maximizing the quantity of soluble materials and minimizing the quantity of poorly digestible materials), thus improving digestion quality. In other words, hydrolysis will speed up solubilization in step d) and make solubilization more homogeneous, and these advantages are all the greater when hydrolysis is accompanied by a grinding step.

According to one embodiment, an additive is added to mixture M1 to be treated upstream of the hydrolysis device or to the mixture during hydrolysis or to mixture M1h downstream of the hydrolysis device.

According to one embodiment, a controlled amount of steam can be injected into the hydrolysis reactor and diffused through mixture M1. This control can be carried out by measuring the temperature in the hydrolysis reactor. Once the setpoint temperature has been reached, steam injection can be stopped.

Steam can be injected:
upstream of hydrolysis into the inlet with a dynamic mixer type mixer, and/or
directly into the hydrolysis reactor, preferentially in the lower part in a tangential manner to avoid clogging by sludge, and/or
in a hydrolyzed sludge recirculation loop.

According to one embodiment, during hydrolysis, mixture M1 is mixed, for example it is stirred.

The hydrolysis reactor may be a batch reactor, which is optionally stirred.

Prior to pressurization b), the treatment method may optionally comprise a grinding step, preferably mechanical grinding.

When present, the step of grinding mixture M1 may be carried out before, during or after hydrolysis. In the latter case, grinding is then carried out on mixture M1h.

When the method of the invention carries out a hydrolysis step combined with a grinding step, then the method of the invention may optionally comprise a step of recirculating at least one fraction of the ground hydrolysate at the start of the hydrolysis step.

According to one embodiment, the hydrolysis reactor(s) comprise(s) a recirculation loop equipped with a grinding device, allowing at least one fraction of the hydrolysate to be introduced into said grinding device and at least one fraction, preferably all, of the hydrolysate thus ground to be returned to the start of the hydrolysis step.

The purpose of this grinding step is to reduce the particle size of mixture M1, typically so that the particle size of the solid fraction is less than 1000 μm, preferably less than 500 μm and more preferably less than 100 μm.

A particle size “less than X μm” means that 95% of solid particles are retained on a sieve with a square mesh size of X μm and that the remaining 5% are no larger than 3 times X μm.

In addition to the reduction in particle size which minimizes downstream clogging, the grinding step homogenizes mixture M1 and reduces the viscosity thus allowing much better control of the heating and solubilization.

Like the hydrolysis step, grinding and particle size reduction also contribute to biomass homogenization and solubilization thereof.

In high-pressure reactors, it is difficult to achieve mechanical stirring, and the viscosity reduction achieved by virtue of the hydrolysis step and/or the grinding step further improves internal turbulence and therefore homogenization in pressurized reactors.

### Pressurization Step B)

The method according to the invention comprises a step of pressurizing mixture M1h at a pressure ranging from 20 to 350 bar, preferably 50 to 300 bar, preferably ranging from 150 to 270 bar, preferably from 170 to 220 bar, preferably from 170 to 210 bar. A stream of mixture M1p is obtained.

In particular, pressurization allows mixture M1h to be brought to a pressure sufficient for the mixture to be in a predominantly liquid phase. More specifically, the pressure in mixture M4 will typically be higher than the saturated vapor pressure of said mixture M4 to maintain the water in liquid phase.

For the pressurization step, a pump may be provided on the line at the outlet of the hydrolysis reactor.

In another embodiment, a dedicated pump supplies the pressurization pump.

### Heating Step C)

The method according to the invention comprises a step of heating mixture M1h resulting from step b) to a temperature ranging from 250 to 450° C., preferably ranging from 250 to 400° C., still preferably from 300 to 400° C.

A stream M2 is obtained at the end of heating step c).

The heating step can be carried out in a heat exchanger, for example by heat exchange using stream M4 enriched with soluble materials resulting from step d) of the method as the heating fluid.

The heating step c) may optionally comprise several heating sub-steps via one or more heat exchangers.

Preferably, at least one heating sub-step is carried out by heat exchange using stream M4 enriched with soluble materials resulting from step d) of the method as the heating fluid.

Advantageously, when the heating step comprises at least two heating sub-steps, at least one of these sub-steps is carried out at high speed.

Thus, according to a preferred embodiment, at least one heating sub-step is carried out at a rate greater than or equal to 100° C./minute, preferably greater than or equal to 200° C./minute, even more preferably greater than or equal to 400° C./minute.

Thus, in at least one heating sub-step, to achieve a high heating rate when a heat exchanger is used, it is advisable to have as high an average delta T as possible, typically greater than 50° C., preferably greater than 100° C., preferably greater than 200° C.

The average delta T is the average of the delta T values at all points of the exchanger. The average delta T can be calculated as the logarithmic delta T taken from the inlet temperatures and the outlet temperatures of each fluid.

The heating step c) can thus be a combination between on the one hand the heat exchange with stream M4 whose absolute temperature is limited by the needs of the process and on the other hand the heat exchange with another fluid which may itself be heated by electricity, hot gases or directly available heat from an external source or finally the exchanger may be directly heated by electricity through induction, thermal resistance or microwaves.

Thus, a heat exchanger may be present downstream of the pressurization pump, said heat exchanger being configured to recover heat from stream M4 enriched with soluble materials resulting from step d) and to heat mixture M1p prior to solubilization step d).

According to one embodiment, an additive is added upstream of the solubilization step, in the stream of mixture M1p during the heating step of step c) and/or downstream of step c) in stream M2.

According to one embodiment, the additive is selected from oxidizing agents such as liquefied oxygen, hydrogen peroxide, air or permanganate salts such as potassium permanganate, or from alkaline reagents such as for example KOH, NaOH, KHCO3, K2CO3, CaO, Ca(OH)2, CaCO3, Ca(HCO3)2, Mg(OH)2, MgO.

If the method comprises a step of adding an additive of the oxidizing agent type, then preferably said adding step is implemented in the stream of mixture M2 downstream of heating step c).

According to an advantageous embodiment, the installation for implementing the method comprises at least one heat exchanger dimensioned to allow rapid heating of mixture M1p, for example at a rate greater than or equal to 100° C./minute, preferably greater than or equal to 200° C./minute, even more preferably greater than or equal to 400° C./minute.

Viscosity is the key element to improving heating rates.

Thus, hydrolysis step a) is advantageously carried out so that the viscosity of the hydrolyzed waste (M1p) is compatible with the desired heating rate in step c).

Failure to reach the design temperatures (setpoint) at the end of heating step c) is an indicator that the viscosity in mixture M1h is still too high. A viscosity measurement at the end of hydrolysis will also make it possible to verify the reduction in viscosity.

According to one embodiment, the method comprises continuous measurement of the viscosity in mixture M1h.

Too slow a heating rate in step c) can lead to uncontrolled parasitic reactions (char-tar) due to excessively long residence times.

### Step D)

Step d) of the method of the invention comprises:
a solubilization step (step d1) carried out on at least one fraction of mixture M2 resulting from step c),
optionally a heating step (step d2) at a temperature ranging from 250 to 450° C., and
a separation step (step d3) in order to obtain a stream M4 enriched with soluble materials and a stream M3 depleted of soluble materials.

Step d) of the method is carried out in one or more reactors with an overall hydraulic residence time of less than or equal to 20 minutes, preferably less than or equal to 10 minutes, preferably less than or equal to 5 minutes.

The overall hydraulic residence time is the average residence time of a drop of M2 from the entry of the M2 material (start of step d)) to the exit of stream M4 enriched with soluble materials (end of step d).

The reactor(s) used to carry out step d) may be tubular reactors and/or continuous stirred tank reactors and/or baffled tank reactors or other types of reactor allowing uniform residence times in the reactor, said reactor(s) optionally comprising one or more filters.

### Solubilization Step D1)

The method according to the invention comprises a step d1) of solubilizing at least one fraction of mixture M2 resulting from step c). Preferably, the solubilization step is carried out on all of mixture M2 resulting from step c).

The solubilization step makes the organic matter in mixture M2 homogeneous in a hydrothermal medium and makes at least some of the organic matter in mixture M2 soluble.

Thus, typically, this solubilization step is distinct from a liquefaction step where the organic matter becomes insoluble in water (oil formation) and can therefore separate from the water.

Advantageously, the solubilization step does not comprise oil formation.

The solubilization step produces a mixture M6 also known as liquid solution M6.

Thus, the liquid solution M6 will typically comprise at least organic matter and at least inorganic matter.

According to one embodiment, the solubilization step is carried out in a tubular reactor or in a continuous stirred tank reactor.

Preferably, the residence time in solubilization step d1) is less than or equal to 20 minutes, preferably less than or equal to 10 minutes, preferably less than or equal to 5 minutes.

### Possible Heating Step D2)

The method according to the invention may optionally comprise, during step d), a heating step (step d2) of all or part of the mixture present during solubilization, prior to separation step d3).

Preferably, when carried out, heating step d2) is carried out on the entire mixture present during solubilization, prior to separation step d3).

When carried out, heating step d2) heats the mixture to a temperature ranging from 250 to 450° C., preferably from 250 to 400° C., even more preferably from 300 to 400° C.

This step d2) allows a thermal range to be reached which favors separation of the soluble fraction from the insoluble fraction by gravity by virtue of the modification of the precipitation constants and of the density of the medium.

The heating step can be carried out by direct heating or by indirect heating, for example by heat exchange.

The heating step can be carried out in the solubilization reactor(s) or in one or more reactors downstream of the solubilization reactor(s).

At the end of optional heating step d2), the heated mixture is referred to as mixture M6′.

### Separation Step D3)

The method according to the invention comprises a step d3) of separating at least one fraction of the mixture obtained after solubilization d1) and where applicable after heating d2), in order to obtain a stream M4 enriched with soluble materials and a stream M3 depleted of soluble materials.

For the purposes of this invention, “stream enriched with soluble materials” means a stream comprising a mass proportion of soluble materials greater than the mass proportion of soluble materials in mixture M2.

For the purposes of the present invention, “stream depleted of soluble materials” means a stream comprising a mass proportion of soluble materials less than the mass proportion of soluble materials in mixture M2.

A soluble material will be the material obtained after filtration through a 40 μm filter (material not retained by said 40 μm filter) and subsequent drying of an initial material.

According to one embodiment, the ratio between the concentration of soluble materials in stream M4 enriched with soluble materials in mixture M2 is greater than or equal to 2, preferably greater than or equal to 5.

Separation step d3) can be carried out in the reactor(s) of step d).

Thus, according to one embodiment, this separation step d3) can be carried out in the same reactor(s) as solubilization step d1).

Alternatively, separation step d3) can be carried out in a separate separation device comprising a feed line for mixture M6 resulting from step d1) or where applicable mixture M6′ resulting from step d2) and two outlet lines: (i) a line for extracting stream M3 depleted of soluble materials and (ii) a line for extracting stream M4 enriched with soluble materials.

The separation device can be a gravitational or hydraulic cyclone-type separation device typically fitted at the bottom with a continuous or intermittent or filtration discharge system.

According to an advantageous embodiment, step d) is carried out in a reactor that allows residence times to be differentiated between the so-called solid fraction (enriched with insoluble materials) and the so-called liquid fraction (enriched with soluble materials).

This differentiation of residence times can for example be implemented via a filter placed in the reactor in step d) which allows the liquid to pass through without the solid passing through.

This differentiation of residence times not only minimizes liquid residence times to avoid the formation of recombinant products but also allows time for the solubilization of non-solubilized material which will remain in the reactor for longer in step d).

According to one embodiment, the reactor in step d) comprises an outlet for a stream M3 depleted of soluble materials.

The method is thus designed to separate solubilized material from non-solubilized material, at the end of step d).

Typically, the separation step is carried out by controlling the mass residence time, preferably by controlling the residence time of soluble materials.

Thus, according to an advantageous embodiment, the separation step comprises an extraction of stream M4 enriched with soluble materials followed by an extraction of stream M3 depleted of soluble materials, preferably via two different outlets. In particular, the residence time of the insoluble material will be controlled.

Stream M3 can be extracted via a continuous or non-continuous (for example sequenced) outlet, allowing a longer residence time for this insoluble material than for the soluble material.

The extraction of stream M4 can be controlled based on the input of stream M2.

For example, if the reactor comprises two outlets, preferably, stream M4 enriched with soluble materials will be extracted through an outlet at the top of the reactor and stream M3 depleted of soluble materials will be extracted through an outlet at the bottom of the reactor.

Preferably, the outlet at the top of the reactor is located at a higher altitude than the inlet and the outlet at the bottom of the reactor is located at a lower altitude than the inlet.

According to one embodiment, the heat present in stream M4 enriched with soluble materials resulting from step g) is recovered, said recovered heat preferably allowing mixture M1p to be at least partially heated during step c) and/or mixture M1 during step a).

Preferably, this heat recovery is carried out by heat exchange between stream M4 enriched with soluble materials resulting from step d) and mixture M1p and/or M1.

According to one embodiment, at least one additive is added to stream M3 depleted of soluble materials resulting from step d). According to one embodiment, said additive is added to stream M3 in a recovery reactor located downstream of the outlet of stream M3.

Preferably, said additive is selected from oxidizing agents such as liquefied oxygen, hydrogen peroxide, air or permanganate salts such as potassium permanganate, or from magnesium salts such as for example magnesium hydroxide (Mg(OH)2), magnesium oxide (MgO) or magnesium chloride (MgCl2) or from alkaline reagents such as for example KOH, NaOH, KHCO3, K2CO3, CaO, Ca(OH)2, CaCO3, Ca(HCO3)2, Mg(OH)2, MgO, or from ammonia solutions such as ammonium hydroxide or ammonium chloride or from a mixture of these reagents.

When a recovery device is used, then it is possible to allow a residence time making it possible then to precipitate the salts targeted by the addition of said additive.

According to one embodiment, mixture M1 comprises phosphorus and stream M3 depleted of soluble materials resulting from step d) comprises at least 70% by weight of the total weight of phosphorus present in mixture M1. In other words, at least 70% by weight of the phosphorus present in mixture M1 is recovered in stream M3 depleted of soluble materials resulting from step d).

According to one embodiment, mixture M1 comprises phosphorus and stream M3 depleted of soluble materials resulting from step d) comprises phosphorus, preferably in a proportion ranging from 1 to 20% by dry weight, with respect to the total dry weight of stream M3 depleted of soluble materials resulting from step d).

According to one embodiment of the method, at least a first additive is added to mixture M upstream of step d) and at least a second additive is added to stream M3 depleted of soluble materials resulting from step d), the first additive preferably being different from the second additive.

The mixture M upstream of step d) can thus be:
mixture M1 upstream of step a),
mixture M1 during step a),
mixture M1h upstream of step b),
mixture M1p upstream of step c),
mixture M1p during step c), or
mixture M2 downstream of step c) and upstream of step d).

Preferably, said additives are selected from oxidizing agents such as liquefied oxygen, hydrogen peroxide, air or permanganate salts such as potassium permanganate, or from magnesium salts such as for example magnesium hydroxide (Mg(OH)2), magnesium oxide (MgO) or magnesium chloride (MgCl2) or from alkaline reagents such as for example KOH, NaOH, KHCO3, K2CO3, CaO, Ca(OH)2, CaCO3, Ca(HCO3)2, Mg(OH)2, MgO, or from ammonia solutions such as ammonium hydroxide or ammonium chloride or from a mixture of these reagents.

### Cooling and Expansion Step E)

The method according to the invention comprises a cooling step and an expansion step carried out on at least one fraction, preferably all, of stream M4 enriched with soluble materials resulting from step d), in order to obtain a cooled and expanded stream M5.

Stream M5 is a liquid stream that may optionally comprise an insoluble gaseous fraction.

According to one embodiment, stream M4 enriched with soluble materials is cooled to a temperature less than or equal to 60° C., preferably less than or equal to 40° C., prior to being expanded.

Cooling can be carried out using a cooling device selected from a heat exchanger which may or may not be integrated with a Rankine, flash or scrubber cycle.

According to one embodiment, cooled stream M4 is expanded in an expansion device up to a pressure ranging from 1 to 10 bar. A cooled and expanded stream M5 is obtained. This expansion step reduces the pressure before injection into the digester, a device that is generally under low overpressure (less than 1 bar relative).

According to this embodiment, the cooled and expanded stream M5 supplies the digestion device.

Following expansion and prior to digestion, it is possible to separate any gaseous fraction present in stream M5 and rendered insoluble by expansion and to specifically recover this gaseous fraction in order to specifically send at least part of the gaseous fraction into the digester, for example via an inlet different from that of stream M5, or into another device.

As described in the heating phase, stream M4 can partially or fully heat stream M1p in heating step c) and/or stream M1 in step a).

If, in order to achieve sufficiently high heating rates, stream M4 heats only part of stream M1p, the other part of stream M1p may be heated by another fluid in step c), and in this case, stream M4 is generally not sufficiently cooled; this cooled stream is referred to as stream M4′.

In this case, the residual heat of stream M4′ can be used to heat fluid M1 during the hydrolysis step, for example by expanding stream M4′ at a pressure of 2-10 bar, with the expansion steam thus being used in this case to heat mixture M1 by direct injection.

According to this embodiment, heating step c) is partially carried out in a heat exchanger, said heat exchanger allowing stream M1p to be partially heated and stream M4 resulting from step d) to be partially cooled.

According to this embodiment, partially cooled stream M4′ is further cooled by expansion in a cooling device, producing steam which can then be injected into the hydrolysis reactor in step a).

If necessary, cooled stream M4′ could undergo a second cooling, downstream of the first cooling, for example by dilution with water or by heat exchange with a cold source to reach a temperature of less than or equal to 60° C., preferably less than or equal to 40° C.

Thus, the cooling step can be carried out in one or more cooling devices in series.

According to one embodiment, the method of the invention further comprises a separation step e′) carried out on at least one fraction of stream M5 resulting from step e) to obtain a gaseous fraction FG and a liquid stream M5′. According to this embodiment, digestion step f) will then preferably be carried out on at least one fraction, preferably all, of liquid stream M5′.

### Digestion Step F)

The method according to the invention comprises at least one digestion step, preferably an anaerobic digestion step. For example, anaerobic digestion after hydrolysis and separation of inorganic matter increases biogas production with respect to standard digestion as lignin or cell wall type organic polymers have been solubilized and broken down into shorter, more easily digestible chains and there is less competition between methanogenic and inorganic-reducing bacteria.

The digestion step f) is carried out in a digestion device.

The digestion device in step f) is supplied with at least one fraction of stream M5 resulting from step e), preferably with all of stream M5, and/or, when step e′) is present, with at least one fraction of liquid stream M5′ resulting from step e′), preferably all of stream M5′.

According to the embodiment implementing a separation step e′), then preferably, the digestion device will be supplied by at least two inlets, a first inlet for introducing liquid stream M5′ and a second inlet for introducing the gaseous fraction FG.

### Anaerobic Digestion May Be Mesophilic or Thermophilic.

When mesophilic digestion is used, the temperature in the digester ranges from 33° C. to 37° C. and the residence time is 16 to 22 days.

When thermophilic digestion is used, the temperature in the digester ranges from 55° C. to 60° C. and the residence time is 10 to 12 days.

Residence time and temperature are two factors influencing the proper degradation of sludge and therefore the optimization of energy production.

In the context of the present invention, since the stream to be digested is sufficiently liquid, digestion can be of the UASB type and residence times reduced.

At the end of digestion step F), a biogas is obtained.

This biogas typically comprises a mixture substantially consisting of methane, carbon dioxide and water. The biogas may optionally comprise other gases, such as hydrogen, oxygen, nitrogen, hydrogen sulfide but these other gases collectively represent less than 10% of the total weight of the biogas.

### Possible Step(s) for Recovering Stream M3

Stream M3 depleted of soluble materials resulting from step d) will typically comprise organic matter and inorganic matter.

According to one embodiment, the method further comprises at least one step of recovering at least one fraction of stream M3, said at least one recovery step being preferably selected from a hydrothermal gasification step, a wet oxidation step (WOS).

This additional step will allow the organic matter still present in this stream M3 to be recovered while simultaneously recovering the insoluble inorganic matter present in this stream M3. Thus, this stream M3 which could be considered a non-recoverable waste using state-of-the-art methods, will generate recoverable by-products.

Thus, the method of the invention will allow on the one hand excellent solubilization to allow good quality digestion and on the other hand conversion of stream M3 into a recovered material.

Hydrothermal gasification (HG) is a thermal depolymerization process used to convert organic matter present in a humid environment into a mixture comprising only small molecules under high to moderate temperature and pressure.

During the HG process, the carbon and hydrogen in an organic matter are converted thermochemically under near-critical or supercritical conditions. Part is converted into water-soluble compounds with low molar masses.

Another part is converted into gaseous products such as carbon dioxide (CO2), methane (CH4), dihydrogen (H2), carbon monoxide (CO), light hydrocarbons such as ethane (C2H6) and propane (C3H8).

During residence in the hydrothermal gasification reactor at temperatures less than 400° C., the organic matter undergoes, among other reactions, hydrolysis-based decomposition, similar to the reactions occurring in the liquefaction process, but much more rapidly. In fact, implementation under near-critical or supercritical conditions makes it possible to use the unique properties of supercritical water as a solvent, allowing homogeneous solvation and reaction conditions, leading to very high reaction kinetic speeds. As a result, a much shorter residence time and a much higher heating rate than in conventional hydrolysis are used, limiting or even avoiding the secondary condensation and polymerization reactions responsible for bio-oil and bio-char formation.

When the HG operates at temperatures above 400° C., radical decomposition of polymers (involving in particular decarboxylation, deamination reactions by breaking C—N bonds, and C—C or C—O cleavage) predominates, while endothermic steam reforming is the main reaction pathway for converting small molecules with 1 to 3 carbon atoms into carbon oxides and dihydrogen, and nitrogen into ammonia.

Methane is also produced by the methanation of CO and CO2, using dihydrogen.

Consequently, HG can be seen as a decomposition method transforming the organic residue present in the stream M3 into a more readily biodegradable matter and ammonia dissolved in the liquid phase.

The treatment conditions (in particular temperature, pressure, and to a lesser extent residence time) of the HG can be adjusted to not only produce a gaseous fraction containing CH4, CO, CO2 and H2 (synthesis gas), but also to produce an aqueous effluent, containing mainly easily digestible compounds, notably carboxylic acids, on the one hand, and ammonia in the form of the ammonium salt of the carbonic acids produced, on the other hand.

It should be noted that HG is different from hydrothermal liquefaction (HTL), in particular in that the conversion rate and level of decomposition of organic matter in HTL are not as high as in HG, even when HG is operated under moderate temperature conditions.

Under HTL conditions, the water still contains HO− and H3O+ ions which initiate the hydrolysis of organic matter.

Hydrolysis only takes place on the surface of the cellulose compounds contained in the organic fraction which dissolves very little in the subcritical medium, resulting in fairly low decomposition conversions.

Condensation reactions (comprising mainly Aldol condensation, alkylation or Friedel-Craft acylation) of intermediates are an important reaction pathway, leading to the formation of biocrude which is an oil (also called bio-oil) that can be used as a fuel, that is, biocrude contains organic molecules containing 5 or more carbon atoms, generally from 8 to 16 carbon atoms. The liquid product of HG, on the other hand, contains mainly readily biodegradable compounds.

HG differs from pyrolysis in that it is carried out in a medium containing water, the water being in a supercritical or near-critical state.

HG differs from “conventional” gasification of organic matter in that “conventional” gasification reduces the carbon/hydrogen (C/H) mass ratio, resulting in products with increased calorific value, including a gas composed mainly of synthesis gas (H2/CO mixture), bio-oil and/or carbonaceous solid (char).

In the treatment method according to the invention, the hydrothermal gasification step is typically carried out in a hydrothermal gasification reactor, supplied at the inlet with at least one fraction of stream M3, said fraction of stream M3 may result directly from step d) or said fraction of stream M3 may be pressurized and/or preheated and/or supplemented with an additive upstream of the gasification reactor.

According to one embodiment, the gasification reactor is a tubular reactor.

Preferably, the hydrothermal gasification step is carried out at a temperature below 600° C., preferably at a temperature ranging from 350° C. to less than 600° C., even more preferably ranging from 450 to less than 600° C.

Preferably, the hydrothermal gasification step is carried out at a pressure greater than or equal to 220 bar, preferably greater than or equal to 250 bar.

Preferably, the (overall) residence time of stream M3 in the HG step typically ranges from 1 min to 20 min, preferably from 2 min to 10 min, more preferentially from 3 to 5 min.

In a preferred embodiment, the hydrothermal gasification step is carried out in the presence of a catalyst. Preferably, the catalyst is chosen from metals on activated carbon, such as ruthenium, nickel, palladium or platinum. The catalyst can be in the form of a bed of solid particles within the gasification reactor.

Wet oxidation destroys organic matter while producing heat for heating step c) and acetic acid which can be sent to digestion step f).

The invention also relates to an installation for implementing the treatment method according to the invention.

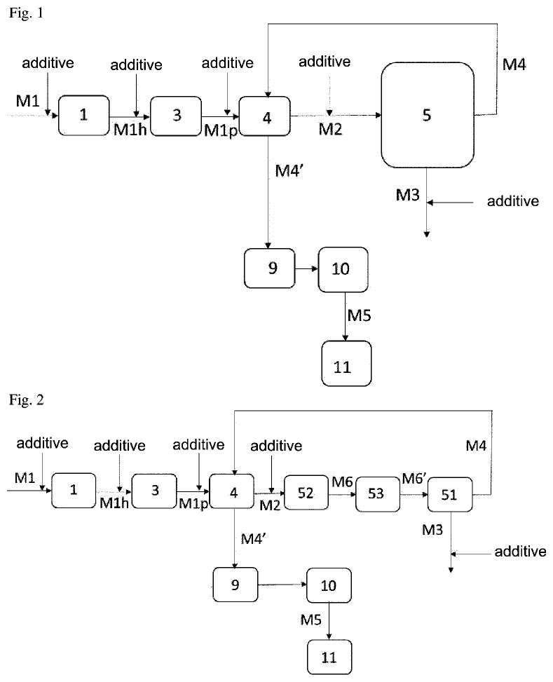

FIG. 1 to FIG. 3 show an installation according to the invention, without limiting the scope thereof.

The installation according to the invention comprises:
one or more hydrolysis reactors 1 optionally comprising a stirring device, supplied at the inlet by a feed line for mixture M1 to be treated and comprising an outlet line for hydrolyzed mixture M1h, said hydrolysis reactor(s) 1 optionally being preceded by a grinding device or provided with a recirculation loop equipped with a grinding device or followed by a grinding device, upstream of the pump 3,
a pressurization pump 3 supplied at the inlet by hydrolyzed mixture M1h which is optionally ground,
a heating device 4 comprising an inlet for introducing at least one fraction of mixture M1p, and comprising at least one outlet for mixture M2,
a reactor 5 comprising an inlet for introducing at least one fraction of the mixture M2 resulting from the heating device 4 and comprising at least two outlets, one outlet for the stream M3 and one outlet for the stream M4,
said reactor 5 optionally comprising heating means, and
said reactor 5 comprising separation means for extracting a stream M3 depleted of soluble materials and a stream M4 enriched with soluble materials,
optionally a heat exchanger 9 for recovering the heat present in stream M4 enriched with soluble materials at the outlet of the reactor 5,
an expansion device 10 supplied with at least one fraction of stream M4 enriched with pre-cooled soluble materials, and comprising an outlet for stream M5,
optionally a separation device 12 supplied by at least one fraction of stream M5 and comprising an outlet for a gaseous fraction and an outlet for liquid stream M5′,
a digestion device 11 supplied with at least one fraction of stream M5 or where applicable with at least one fraction of liquid stream M5′ and at least part of the gaseous fraction.

Preferably, the reactor 5 comprises one or more filters.

According to one embodiment shown in FIG. 2, the reactor 5 comprises:
a solubilization reactor 52 comprising an inlet for introducing at least part of mixture M2 resulting from the heating device 4 and comprising an outlet line for a mixture M6,
optionally a heating device 53 comprising an inlet for introducing at least part of mixture M6 resulting from the solubilization reactor 52 and comprising an outlet line for a mixture M6′,
a separation device 51 supplied with at least one fraction of mixture M6 or with at least one fraction of mixture M6′ when a heating device 53 is present, and comprising at least two outlets, one outlet for stream M3 and one outlet for stream M4.

According to one embodiment, the separation device 51 consists of one or more filters.

According to one embodiment, the heating device 4 is a heat exchanger for exchanging heat between the heat of stream M4 resulting from the reactor 5 and stream M1p downstream of the pressurization pump 3 (and upstream of the reactor 5).

According to one embodiment, the heat exchanger 9 recovers the heat present in stream M4 and transfers it to mixture M1 in the hydrolysis device 1 or upstream of the hydrolysis device.

Preferably, the heat exchanger 9 is downstream of the heating device 4 and recovers the heat present in stream M4′.

Thus, according to a preferred embodiment of the installation, the line of stream M4 downstream of the reactor 5 successively comprises a heat exchanger (corresponding to the heating device 4) and a heat exchanger 9 and an expansion device 10.

According to one embodiment of the invention, the expansion device 10 comprises two outlets:
a first outlet for the stream of mixture that will supply the digester 11, and
a second outlet, separate from the first outlet, for steam.

According to this embodiment, the installation further comprises a steam supply line from the second outlet of the expansion device 10 to the feed line for mixture M1 and/or to the hydrolysis reactor 1.

According to one embodiment, the installation further comprises at least one injection device for injecting an additive into at least one element selected from:
The feed line for mixture M1 upstream of the hydrolysis reactor 1,
The hydrolysis reactor 1,
The line of mixture M1h downstream of the hydrolysis reactor 1 and of any grinding device,
The line of mixture M2 downstream of the heating device 4 and upstream of the reactor 5,
The line of stream M3 at the outlet of the reactor 5 (where applicable of the separation device 51).

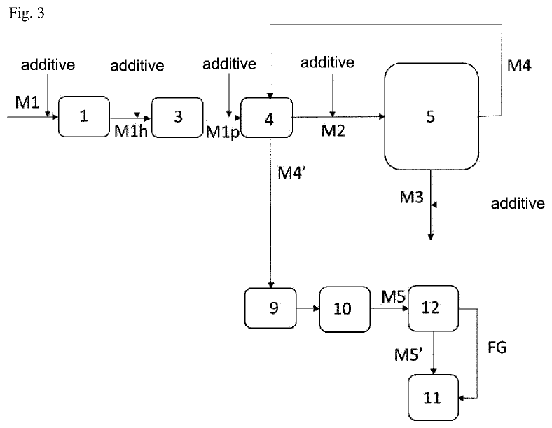

FIG. 3 shows an embodiment of the invention wherein the installation comprises a separation device 12 supplied by the line of stream M5 resulting from device 10, and comprising one outlet for the gaseous fraction FG and one outlet for liquid stream M5′. According to the embodiment shown in FIG. 3, the gaseous fraction FG resulting from the separation device 12 is injected into the digester 11 via an inlet other than the inlet of stream M5′.

Thus, according to one embodiment of the installation according to the invention, the digester 11 comprises two inlets:
a first inlet for introducing at least one fraction of stream M5′ resulting from the separation device 12, and
a second inlet, separate from the first inlet, for introducing at least one fraction of the gaseous fraction FG resulting from the separation device 12.

According to one embodiment of the invention, the installation further comprises, on an outlet line of stream M3 downstream of reactor 5, at least one recovery device, preferably selected from a hydrothermal gasification device or a wet oxidation device, said recovery device preferably being present downstream of the additive injection line when this is present.

The installation according to the invention may of course comprise one or more of the features described as part of the method according to the invention.

1. A method for treating a mixture M1 comprising at least organic matter, said method comprising:
a) hydrolyzing mixture M1 at a temperature ranging from 70 to 165° C. and at a pressure ranging from 1 to 8 bar to obtain a hydrolyzed mixture M1h, the ratio between the viscosity of mixture M1 and the viscosity of mixture M1h being at least 2 ;
b) pressurizing mixture M1h at a pressure ranging from 20 to 350 bar to obtain a stream M1p;
c) heating mixture M1p to a temperature ranging from 250° C. to 450° C., to obtain a mixture M2;
d) solubilizing at least one fraction of mixture M2 , optionally heating at a temperature ranging from 250 to 450° C., and separating to obtain a stream M4 enriched with soluble materials and a stream M3 depleted of soluble materials, said step d) being carried out in one or more reactors with an overall hydraulic residence time less than or equal to 20 minutes;
e) cooling and expanding at least one fraction of stream M4 enriched with soluble materials to obtain a stream M5; and
f) digesting at least one fraction of stream M5.

2. The method according to claim 1, further comprising an additional separation step e′) carried out on at least one fraction of stream M5 resulting from step e) to obtain a gaseous fraction FG and a liquid stream M5′, the digestion step f) then being carried out in a digester on at least one fraction of liquid stream M5′.

3. The method according to claim 1, wherein the separating comprises extracting stream M4 enriched with soluble materials and extracting stream M3 depleted of soluble materials, controlled outlets.

4. The method according to claim 1, wherein the heating step c) comprises at least two sub-steps, at least one of said sub-steps allowing mixture M1p to be heated at a rate greater than or equal to 100° C./minute.

5. The method according to claim 1, wherein the heat present in stream M4 enriched with soluble materials resulting from step d) is recovered.

6. The method according to claim 5, wherein heat is recovered by heat exchange between stream M4 enriched with soluble materials resulting from step d) and mixture M1p.

7. The method according to claim 1, wherein in step e) stream M4 enriched with soluble materials is cooled to a temperature less than or equal to 60° C.

8. The method according to claim 1, wherein the cooling comprises at least two sub-steps.

9. The method according to claim 1, wherein mixture M1 comprises from 5 to 50% by weight of solids with respect to the total weight of mixture M1.

10. The method according to claim 1, wherein at least one additive is added to at least one stream selected from the group consisting of the stream of mixture M1 upstream of step a), the mixture M1 during step a), the stream of mixture M1h upstream of step b), the stream of mixture M1p upstream of step c), the mixture M1p during step c), the stream of mixture during step d), and the stream M3 depleted of soluble materials resulting from step d).

11. The method according to claim 1, further comprising at least one step of recovering at least one fraction of stream M3.

12. An installation suitable for carrying out the method of claim 1, comprising:
at least one hydrolysis reactor optionally comprising a stirring device, supplied at an inlet by a feed line for mixture M1 to be treated and comprising an outlet line for the hydrolyzed mixture, said at least one hydrolysis reactor being optionally preceded by a grinding device or provided with a recirculation loop equipped with a grinding device or followed by a grinding device, upstream of a pump;
a pressurization pump supplied at the inlet by the hydrolyzed mixture, which is optionally ground, and comprising an outlet line for mixture M1p;
a heating device comprising an inlet suitable for introducing at least one fraction of mixture M1p downstream of the pump, and comprising at least one outlet for mixture M2;
a reactor comprising an inlet suitable for introducing at least part of mixture M2 resulting from the heating device and comprising at least two outlets, one outlet for stream M3 and one outlet for stream M4;
said reactor optionally comprising heating means, and
said reactor comprising separation means suitable for extracting a stream M3 depleted of soluble materials and a stream M4 enriched with soluble materials;
optionally a heat exchanger suitable for recovering the heat present in stream M4 enriched with soluble materials at the outlet of the reactor;
an expansion device supplied with at least one fraction of stream M4 enriched with pre-cooled soluble materials, and comprising an outlet for stream M5;
optionally a separation device supplied by at least one fraction of stream M5 and comprising an outlet for a gaseous fraction and an outlet for liquid stream M5′; and
a digestion device supplied by at least one fraction of stream M5 or where applicable by at least one fraction of liquid stream M5′ and at least part of the gaseous fraction.

13. The installation according to claim 12, wherein the reactor further comprises:
a solubilization reactor comprising an inlet suitable for introducing at least part of mixture M2 resulting from the heating device and comprising an outlet line for mixture M6;
optionally a heating device comprising an inlet suitable for introducing at least part of mixture M6 resulting from the solubilization reactor and comprising an outlet line for mixture M6′; and
a separation device supplied by at least one fraction of mixture M6 or by at least one fraction of mixture M6′ when a heating device is present, and comprising at least two outlets, one outlet for stream M3 and one outlet for stream M4.

14. The installation according to claim 12, wherein the heating device further comprises a heat exchanger suitable for exchanging heat between stream M4 enriched with soluble materials resulting from the reactor and stream M1p downstream of the pressurization pump a cooled stream M4′ thus being obtained.

15. The installation according to claim 14, further comprising a heat exchanger downstream of the heating device suitable for recovering the heat present in stream M4′ and transferring it to mixture M1 for thermal hydrolysis.

16. The method according to claim 8, wherein said first sub-step is implemented by heat exchange between the heat of stream M4 and mixture M1p to obtain a cooled stream M4′, and said second sub-step comprises expanding cooled stream M4′ at a pressure ranging from 2 to 10 bar to produce expansion steam, said expansion steam is optionally injected into mixture M1 upstream of step a) or during step a).
